(19) United States
(12) Patent Application Publication
(10) Pub. No.: US 2014/0050580 A1
(43) Pub. Date: Feb. 20, 2014

(54) WIND TURBINE WITH ACTUATING TAIL AND METHOD OF OPERATION

(71) Applicant: WEAVER WIND ENERGY, Ithaca, NY (US)

(72) Inventors: Alexander L. Hagen, Ithaca, NY (US); Gary Bush, Groton, NY (US); Arthur J. Weaver, Van Etten, NY (US); Kelly S. Frank, Columbia, PA (US); Ken Bignoli, Cortland, NY (US); Gwendolyn Barr, Brooktondale, NY (US)

(73) Assignee: Weaver Wind Energy, Ithaca, NY (US)

(21) Appl. No.: 13/838,728

(22) Filed: Mar. 15, 2013

Related U.S. Application Data
(60) Provisional application No. 61/682,998, filed on Aug. 14, 2012.

(51) Int. Cl. F03D 7/02

(52) U.S. Cl. CPC F03D 7/0208
USPC 416/1; 416/9

(57) ABSTRACT

A horizontal axis wind turbine assembly adapted for use atop a tower includes a frame, a yaw shaft assembly coupling the frame to the tower, an alternator secured to the frame, a shaft coupled to the alternator to produce electrical power, a rotor hub coupled to the shaft, a plurality of blades secured to the rotor hub, and a tail assembly rotatably coupled about a vertical axis to the frame. The tail assembly is operable to move to a first, straight position aligned with the horizontal axis, and a second position rotated an angle θ from the horizontal axis. An actuator is secured to the frame and is adapted to rotate the tail assembly the angle θ from the horizontal axis.

### CROSS REFERENCE TO RELATED APPLICATION

Reference is made to and this application claims priority from and the benefit of U.S. Provisional Application Ser. No. 61/682,998, filed Aug. 14, 2012, entitled “WIND TURBINE WITH ACTUATING TAIL AND METHOD OF OPERATION”, which application is incorporated herein in its entirety by reference.

### FIELD OF THE INVENTION

This disclosure relates generally to horizontal axis wind turbines and, more specifically, to a wind turbine having an actuating tail for overspeed protection.

### BACKGROUND OF THE INVENTION

Horizontal axis wind turbines generally comprise main body or nacelle pivotally mounted to a tower. A bladed rotor mounts to the nacelle, and a shaft from the rotor connects to an electrical alternator or generator. Although referred to as “horizontal axis” wind turbines, it should be noted that the axis of rotation of the blades may vary by as much as 45 degrees from horizontal, but the wind turbine is still referred to as horizontal axis. One important aspect of a horizontal axis wind turbine is that the plane of the rotor faces the wind to develop the highest rotational speed and therefore, highest energy output. To this end, small horizontal axis wind turbines (e.g., typically less than 100 kilowatt) often utilize a tail structure with a vane to point the rotor into the wind. The surface area of the vane is sized large enough so that any significant shift in wind direction will generate sufficient side forces on the vane to rotate the rotor head into the direction of the wind. The side forces on the vane fall to zero as re-alignment occurs.

One noted problem with horizontal axis wind turbines is overspeed of the rotor. An inadequate braking system can cause the rotor and blades to overspeed in high winds, which can damage the blades and alternator of the wind turbine, and induce excessive noise, vibration, and pitch force during rotation about the yaw (vertical) axis.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 depicts a side perspective view of a wind turbine assembly according to one embodiment of the present invention;

FIG. 2 depicts an enlarged view of the wind turbine assembly shown in FIG. 1, with the nacelle removed for clarity;

FIG. 3 depicts an alternate perspective view of the wind turbine assembly shown in FIG. 1, with the nacelle and rear frame removed for clarity;

FIG. 4 depicts an enlarged view of FIG. 3;

FIG. 5 depicts a top view of the wind turbine assembly shown in FIG. 3;

FIG. 6 depicts the wind turbine assembly shown in FIG. 5 with the tail actuated;

FIGS. 7A, 7B, and 7C respectively depict top views of the wind turbine assembly of FIG. 2 in the unactuated, partially actuated, and fully actuated configuration;

FIG. 8 depicts a schematic block diagram of an on-board computer according to one embodiment of the present invention;

FIG. 9 depicts a schematic block diagram of an on-board computer according to another embodiment of the present invention;

FIG. 10 depicts a block diagram collectively presenting a flow chart illustrating an exemplary embodiment of a method for protecting a horizontal wind turbine assembly;

FIG. 11 depicts a block diagram collectively presenting a flow chart illustrating an exemplary embodiment of another method for protecting a horizontal wind turbine assembly; and

FIG. 12 depicts a graph showing historical wind data.

### DETAILED DESCRIPTION OF THE INVENTION

In FIG. 1, there is shown a wind turbine assembly 1010 rotatably mounted on a tower 1012. The wind turbine assembly 1010 can include a structural frame 1014 to provide support for many of the major components. The frame and wind turbine components are typically covered by a sheet metal, fiberglass, or plastic nacelle 1016 to provide corrosion protection from weather elements. The frame 1014 is secured to a yaw shaft assembly 1018, which is mounted to the tower 1012. The yaw shaft assembly 1018 may include a yaw shaft and bearing, and pivots about a vertical or yaw axis 1020, allowing the wind turbine assembly 1010 to freely rotate (e.g., yaw) with wind direction.

The wind turbine assembly 1010 further includes turbine blades 1022 mounted equidistant from one another on a rotor hub 1024. There are three blades in the illustrated example, but the number may depend upon the particular needs of the application. For example, the wind turbine assembly 1010 may have more than or fewer than three blades. The blades 1022 may be formed of a strong yet lightweight construction, such as aluminum or a composite.

The rotor hub 1024 is connected to a rotatable shaft 1026 (not shown) extending into an alternator housing 1028. Other embodiments may include a geared turbine having a first shaft extending into a gearbox, and a second shaft extended from the gearbox to the alternator housing, the second shaft operating at a different speed than the first shaft. The hub and shaft rotate about a horizontal axis 1030, the axis intersecting with the yaw axis 1020. In this manner and unlike some horizontal wind turbine constructions, the rotor axis is not offset (in the plane of yaw) from the yaw axis. Collectively, as used herein, a “main body” of the wind turbine assembly includes the frame 1014, nacelle 1016, yaw shaft assembly 1018, alternator housing 1028, rotor hub 1024, blades 1022, shaft 1026, and any secondary components attached thereto.

The wind turbine assembly 1010 further includes tail assembly 1032 comprising a rotatable tail boom 1034 on a proximal end 1036 of the tail assembly and a tail vane 1038 on a distal end 1040 of the tail assembly. As used herein, the term “proximal end” means an end towards the wind, and “distal end” means an end away from the wind. As noted, the wind turbine assembly 1010 includes a yaw bearing 1018 to enable the wind turbine assembly to rotate relative to the tower 1012, and in particular to rotate the blades 1022 and rotor hub 1024 so as to face directly into the wind. Rotation of the wind turbine assembly 1010 about the yaw bearing 1018 is facilitated by the tail assembly 1032 mounted downwind of the wind assembly. In particular, the tail vane 1038 is configured and arranged to align with the direction of the oncoming wind 1042. When the wind shifts relative to the horizontal axis 1030, a side load is imparted to the tail vane 1038, pushing the vane sideways and causing the wind turbine assembly 1010 to rotate about the yaw axis 1020 until the side load diminishes, at which point the blades 1022 and rotor hub 1024 are reoriented directly facing into the wind.

The turbine blade should be designed to extract as much kinetic energy from the wind as practical. One measure of blade operational efficiency is the tip speed ratio (TSR), defined as the ratio between the linear speed of the tip of a blade and the actual velocity of the wind. Blades are typically designed to operate at a pre-defined TSR, and an operational goal of the wind turbine is to maintain the designed TSR at varying rotor speeds. That is, the blade extracts the optimum kinetic energy at its designed TSR; if the rotor spins slower (or faster) than the design point, the loading on the blades loses efficiency. Practical considerations generally prevent the wind turbine from operating at its designed tip speed ratio at all operating conditions, and blade designers are faced with various trade-offs to obtain the highest efficiency possible.

One design choice is the material from which the blade is constructed. Blade construction is a critical element of any wind turbine design. Heavier, robust materials such as steel may provide durability, but its inherent weight negatively affects the rotational inertia of the rotor assembly. Rotational inertia can be defined as a measure of the rotor assembly's resistance to any change in its state of rotation, such as change brought about by the additional aerodynamic loading on the blades due to a wind gust. Rotational inertia increases in proportion with mass. Thus, a heavier blade will cause the rotor assembly to resist rotational change more than a lighter blade. Resisting rotational change negatively impacts the tip speed ratio, since an increase in wind speed (as in a gust) will not immediately result in an increase in tip speed because the rotational inertia retards the rotor from accelerating. If the actual tip speed ratio is below its design point, the wind turbine is not running efficiently. Thus, the ability of the rotor to accelerate quickly with wind gusts is an important design consideration.

Another drawback to heavy blade materials is the centrifugal force at the blade root caused by the spinning mass of the blade. The centrifugal force from the spinning blades increases in proportion to its mass, therefore a heavier blade results in a higher centrifugal force at a given speed than a lighter-weight counterpart. Therefore, although heavy blade material can be useful and may be advantageous for certain applications, the aforementioned drawbacks guide blade designers to lightweight constructions such as composites. Typical blade constructions can include plastic or glass-fiber reinforced polymer composites (e.g., fiberglass). Some composite blades may have a foam core, while others may have a carbon fiber-reinforced load-bearing spar for stiffness. In one embodiment, the blades 1022 are formed of fiberglass with a foam core.

One noted problem with composite blades is erosion. The blades encounter particulates in the air such as rain, hail, and dust. The blade tips, being the portion of the blade traveling at the highest speed, can gradually erode, causing them to wear out prematurely. The potential for erosion is exacerbated if the blades encounter a rotor overspeed condition. Even small time durations spent in overspeed conditions, such as tip speeds exceeding 80 meters per second, can result in significant erosion of the blades. Other noted blade problems caused by overspeed are vibration and excessive sound. The turbine blades can become very loud, and the vibration can induce unforeseen stresses, which can affect the entire system.

The wind is an unpredictable energy source. Wind gusts and shifts in direction can result in rapid increases in rotor speed. As can be appreciated, it is important to the safe operation of a wind turbine to control the rotor speed to prevent vibration, noise, and erosion damage to the blades. Overspeed protection is also advantageous to protect other components of the wind turbine. For example, the alternator can overheat and excessive voltages and currents can be generated, all of which decrease the operational lifespan of the wind turbine.

One prior art method of protecting a wind turbine from rotor overspeed utilizes weights on the end of each blade. As the rotor spins faster, centripetal force pitches the blades out of the wind to cause them to become less efficient at high revolutions. Another method involves a two-part blade having a seam at mid-span. At high rotor speed, centripetal force causes the upper portion of the blade to pitch out of the wind to spoil the airflow incident on the leading edge of each blade. Another method, typically used on large-scale wind turbines, employs pitch control on the blades. The wind turbine has an active mechanism within the rotor hub that can pitch the blade, similar to a helicopter blade or an airplane propeller. Yet another mechanism for overspeed control, known as “teetering hub” or “teetering rotor,” utilizes a hinged mechanism such that, if wind forces become too large, the whole wind turbine pitches upward, decreasing the efficiency of the blades and diminishing the surface area pointing into the wind. That is, as the wind turbine pitches up, the projected area of the rotor perpendicular to the direction of the wind decreases, resulting in a decrease in rotor speed.

Some horizontal wind turbines have utilized a passive, rotor furling mechanism to control overspeed. Otherwise known as a self-furling wind turbine, the scheme utilizes a hinged tail portion that permits the main body of the wind turbine to rotate or furl relative to the tail. In effect, a mechanism is provided that furls the blades out of the wind while allowing the tail to remain aligned with the wind. In one example, the rotor furl mechanism utilizes a yaw offset wherein the yaw bearing of the wind turbine is laterally offset a distance from the horizontal axis of the blades and rotor. Forces developed along the horizontal axis by the wind on the rotor blades create a moment about the yaw axis. The moment translates to a torque or turning force about the yaw axis. In low to moderate winds, the torque force is relatively minor, and the wind turbine remains pointed into the wind. In theory, as the wind speed picks up, the wind force along the horizontal axis increases and the reactionary moment (or torque) about the yaw axis also increases. The torque eventually pivots the wind turbine about the yaw axis, turning the rotor and blades out of the wind. Turning the rotor blades out of the wind decreases the efficiency of the blades and the projected area of the rotor perpendicular to the direction of the wind, which will decrease the rotor speed.

Some wind turbines utilizing a passive, self-furling rotor mechanism further include a counterbalance mechanism to provide a restorative force to the yaw offset force. When the wind speed decreases, the counterbalance mechanism helps restore the rotor and blades to their original, unfurled position. In one example, the tail boom is hinged to the nacelle or frame of the wind turbine. The hinge is not positioned vertically (thereby allowing tail movement solely in the yaw plane); rather, the hinge is inclined rearwardly from bottom to top. In this manner, as the rotor furls, rotation about the hinge causes the tail to lift vertically. Thus, any time the nacelle changes direction relative to the tail, the tail raises up. This places the tail assembly under gravitational pressure while the rotor is furled, and enables the tail assembly to move down to its normal working position more easily when the wind speed decreases to normal speed.

Although theoretically plausible, in a practical sense the passive, rotor furling mechanism as described above does not work well. The inventors of the present invention have studied the problem in detail and concluded the self-furling rotor mechanism is unreliable in wind turbines larger than 5 kW because it is too slow to respond. For example, if there is a quick wind gust that rapidly ramps from 20 to 40 mph, and the rotor is designed to furl at 30 mph, the furl mechanism will not respond quick enough and the rotor will remain pointed into the wind, which could cause damage. The inventors have observed that if the rotor starts furling a little bit, but the wind speed and rotor speed are high enough, the rotor tends to straighten itself right back into the wind, regardless of the yaw offset. The reasons for this are thought to be related to the complicated interplay between the wind force, the lift force on the blades, gyroscopic forces, and the yaw offset distance. The designer must strike a balance between how much the tail weighs, the length of the tail, the degree to which the tail is angled, the amount of yaw offset, and the restorative lift force. In some designs, it may be impossible to properly balance the variables to account for all possible combinations of wind speed and direction. Additionally, as the components wear out over time, the delicate balance is thrown off and the passive furling mechanism no longer works as expected, resulting in rotor overspeed and damage to the wind turbine assembly. Failure to correctly balance all the variables may result in a wind turbine that furls too soon. For example, the wind turbine may furl in a 20 mph wind, which is certainly safe, but robs efficiency. A wind turbine rated for 10 kW may actually only produce 6 or 8 kW. In addition, a counterbalance mechanism designed into the tail adds complexity and additional variables to the complicated interplay already in place.

Another noted problem in the operation of small horizontal wind turbines relates to yaw error, which is the difference between the true direction of the wind and the actual direction the blades are pointing. The inventors have noted test data indicating many wind turbines point in the wrong direction by 2 to 6 degrees, resulting in a 1%-2% drop in efficiency. This is a significant loss of available energy over the life of a wind turbine. The inventors have come to appreciate that the causes of the yaw error involve complex interactions of the dynamic motion and forces acting upon the wind turbine, but have nevertheless devised a relatively simple structure and method to compensate for the error, as will be described below.

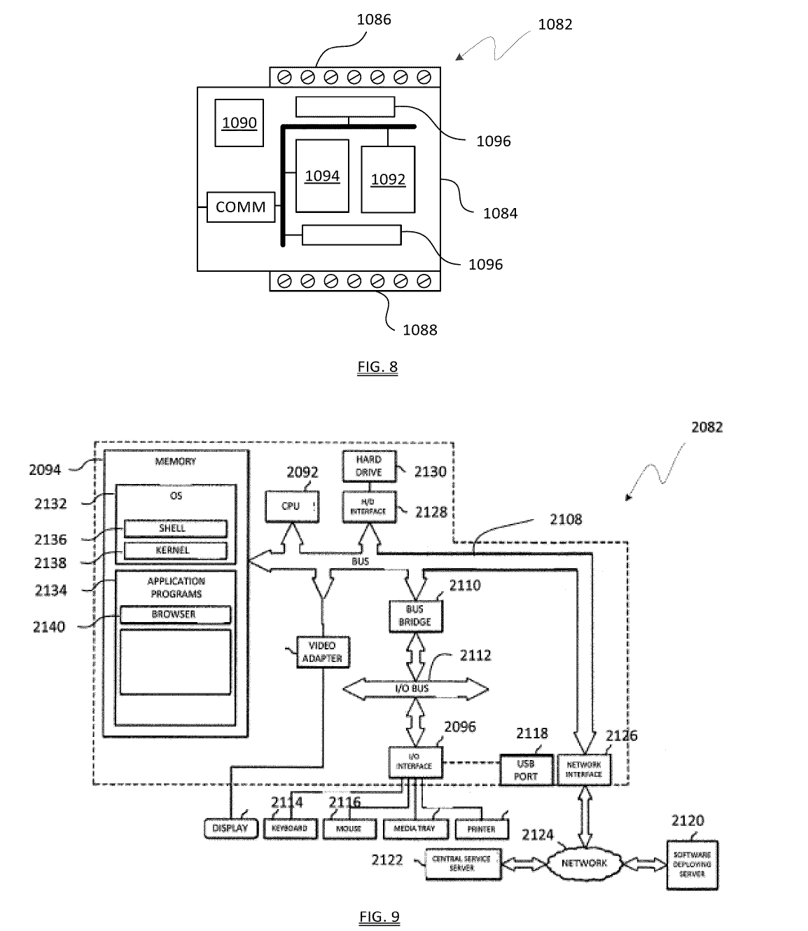

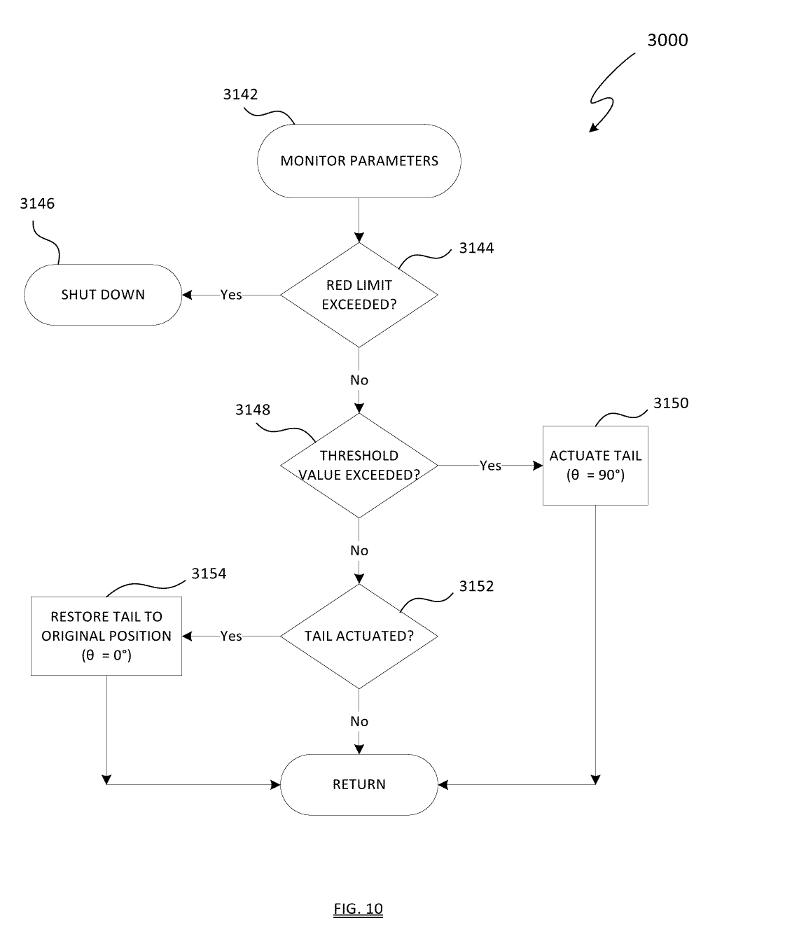

Recognizing the complexities and deficiencies of the various passive, furling rotors found in the prior art, the inventors of the present invention have devised an active tail actuating mechanism. The active component first senses a threshold condition adverse to the health or safety of the wind turbine and, in response, applies force to the tail to actuate it relative to the body of the wind turbine. Once the tail actuates a pre-determined amount relative to the body of the wind turbine, the tail position is fixed, as illustrated in FIG. 7C. Gradually, wind forces “F” on the tail tend to pivot the wind turbine assembly about the yaw axis to re-align the tail with the on-coming wind. Once the actuated tail is re-aligned with the wind, the rotor will no longer face directly into the wind and the rotor speed will decrease. Upon reaching a second, safe threshold condition, the active component restores the tail to its original position. Depending upon the rate at which the active component restores the tail, the tail either stays aligned with the wind or gradually re-aligns with the wind, the net effect of which is to re-align the rotor and blades into the wind.

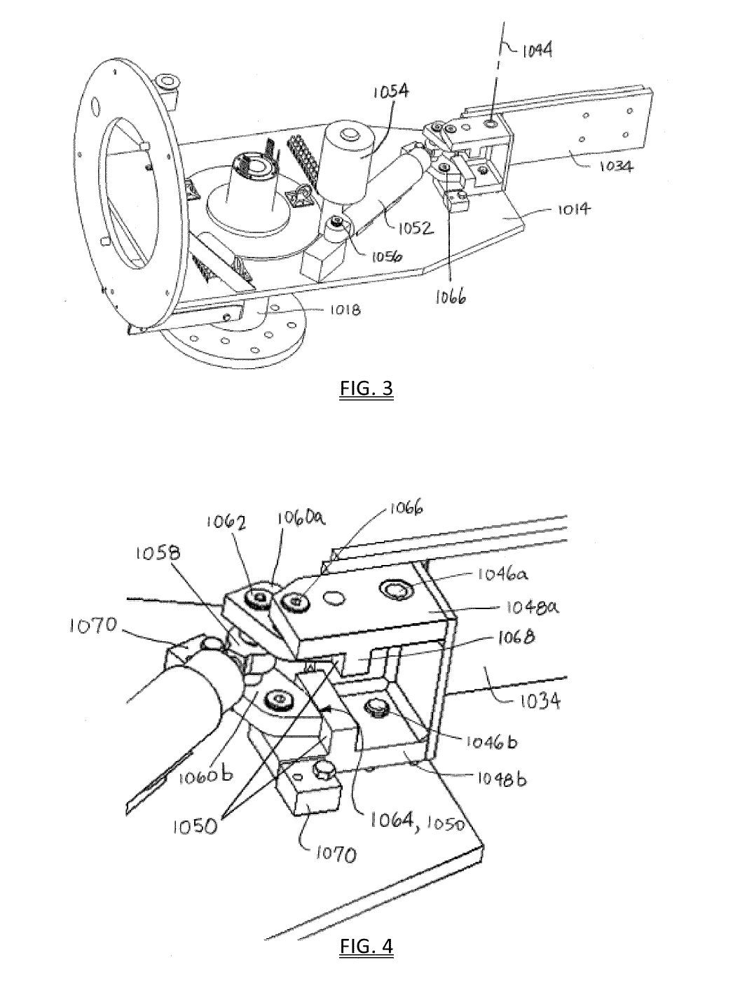

Turning to FIGS. 3-6, the proximal end 1036 of the tail boom 1034 is connected to the distal end 1040 of the main body by a hinged joint that allows the tail assembly to rotate about a generally vertical axis 1044 relative to the main body. As used herein, the main body of the wind turbine generally comprises all components except the tail assembly. In the illustrated embodiment, the hinged joint includes a generally vertically-oriented upper hinge pin 1046a and a corresponding generally vertically-oriented lower hinge pin 1046b secured to the frame 1014 about which the proximal end 1036 of the tail boom 1034 rotates. An upper hinge block 1048a secured to the tail boom 1034 defines a thru hole (not shown) through which the upper hinge pin 1046a engages. Similarly, a lower hinge block 1048b secured to the tail boom 1034 defines a thru hole (also not shown) through which the lower hinge pin 1046b engages. The thru holes may be sized to provide a small clearance for the hinge pins 1046a, 1046b or they may be oversized and fitted with bushings, for example. Alternatively, the holes may be sized for an interference fit with the pin, and the pin may rotate within a bearing. The upper and lower hinge blocks 1048a, 1048b further include contact surfaces 1050 to provide a bearing surface for tail actuation forces. Because the hinge blocks 1048 are secured to the tail boom 1034, actuation forces applied to the contact surfaces 1050 result in the tail assembly 1032 rotating about the hinge pins 1046.

The wind turbine assembly 1010 further includes an actuator 1052 configured to impart actuation forces on the contact surfaces 1050 of the hinge blocks 1048. In one embodiment of the invention, the actuator 1052 is a linear actuator driven by a motor 1054 secured to the frame 1014 by holding bolts 1056. The linear actuator 1052 extends a distance “D” along a generally horizontal axis. One exemplary motor and actuator suitable for use in the present invention is model number SDA4-263 sold by ServoCity, having an extension distance D of approximately four inches.

An eye bolt 1058 may be threadably coupled to the stroke-end of the actuator 1052. Upper and lower cam plates 1060a, 1060b may be positioned above and below the eye bolt 1058. The cam plates 1060 may each define a hole aligned with the eye of the bolt 1058, and an actuator pin 1062 may pass through the three holes to align the parts 1060a, 1058, and 1060b along a common centerline. In one embodiment, the actuator pin 1062 may be rigidly fixed to the upper and lower cam plates 1060a, 1060b such that no relative motion is permitted between the pin and the plates. By way of non-limiting example, the pin 1062 may be press fit, threaded, or welded to the cam plates 1060. However, the actuator pin 1062 may be sized to provide sufficient clearance with the eye of the bolt 1058 to permit the pin to rotate about its longitudinal (e.g., vertical) axis without being constrained by the eye bolt 1058. A sleeve bearing (not shown) may be adapted for the hole in the eye bolt 1058 to extend service life. Conversely, the pin 1062 may be rigidly fixed to the eye bolt 1058, and clearance may be provided in the holes in the upper and lower cam plates 1060a, 1060b to allow relative motion. The holes in the upper and lower cam plates 1060a, 1060b may be adapted with a sleeve bearing or the like (not shown).

The upper and lower cam plates 1060a, 1060b each define a contact surface 1064 adapted to transmit the load from the actuator 1052 to the hinge block 1048 so as to rotate the tail assembly 1032 about the hinge pins 1046. In this manner, the contact surface 1064 on each cam plate engages the contact surface 1050 on each hinge block 1048. The upper and lower cam plates 1060a, 1060b can be coupled to the respective upper and lower hinge blocks 1048a, 1048b. In one embodiment, each cam plate 1060 is coupled to its respective hinge block 1048 by a pin member 1066 that permits relative rotational motion between the two when the cam is in motion.

As illustrated, the hinge blocks 1048 have a transversely-extending ridge 1068 that define the contact surfaces 1050, but other designs are contemplated within the scope of the invention. Further, in the disclosed embodiment the upper and lower cam plates 1060a, 1060b share a common configuration, but the invention need not be so limiting. For example, the upper cam plate 1060a may define a cam surface 1064a adapted to rotate the tail assembly, and lower cam plate 1060b may define a cam surface 1064b adapted for a different purpose.

When the actuator 1052 is in the retracted position, the tail assembly 1032 is held straight relative to the main body of the wind turbine; that is, the longitudinal axis of the tail is aligned with the longitudinal axis 1030 of the main body. The linkages between the motor 1054 and the tail assembly 1032 (e.g., actuator pin 1062, pin member 1066, contact surface 1050, and hinge pin 1046) provide a rigid support structure to prevent the tail from appreciably moving relative to the main body during operation. However, the inventors of the present invention have noted that the top of a wind turbine tower is a harsh environment for mechanical structures. The constant buffeting of the wind subjects the tail assembly to innumerable dynamic forces—in virtually all directions. In one exemplary wind turbine assembly currently in development by the inventor, the tail boom 1034 is approximately 2.4 meters in length. Therefore, wind forces on the tail vane 1038, vibration, and turbulence create very large bending moments about the linked structures anchored to the frame 1014. The bending moments and associated forces of reaction are taken up to some extent by the hinge pin 1046, but the inventors have come to appreciate that a significant percentage of the loads are reacted out through the motor 1054 and corresponding holding bolts 1056 that anchor the motor to the frame 1014.

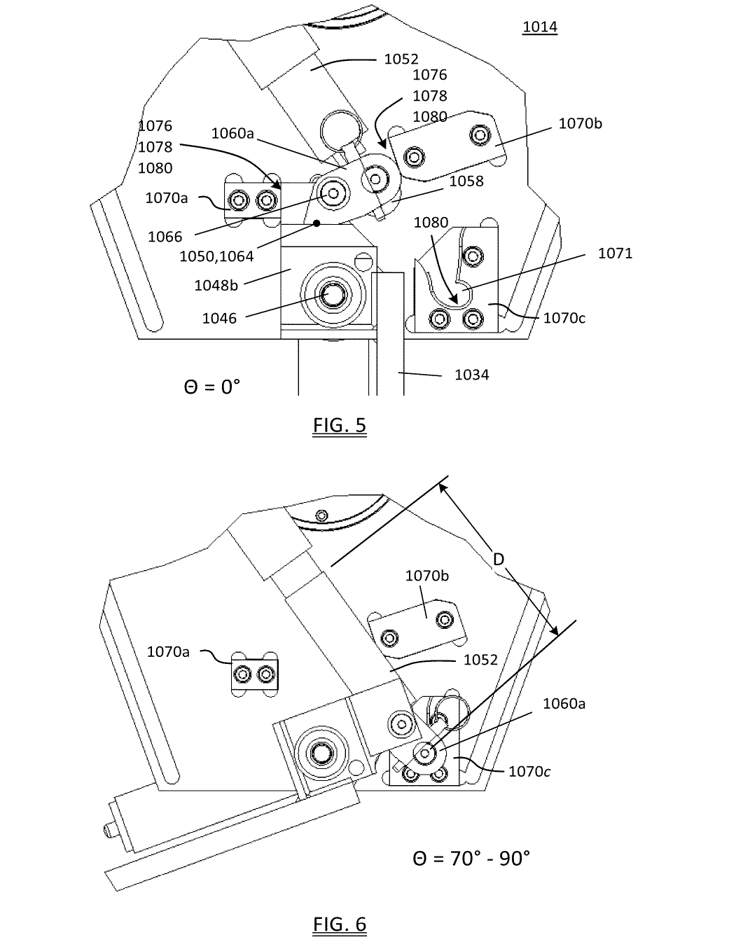

Realizing that the wind turbine operates most of the time in the straight position, and further appreciating the difficulty in designing a motor and mount that could withstand the pummeling delivered by the forces of nature, the inventors of the present invention endeavored to transfer the loads away from the actuator 1052 and holding bolts 1056. In one embodiment of the invention, then, a load absorber element 1070 may be secured to the frame 1014 and positioned to contact a portion of the tail actuation structure in a manner that significantly reduces or even unloads the actuator 1052 and holding bolts 1056. In the illustrated embodiment depicted in FIG. 5, a first load absorber element 1070a is positioned with a first bearing surface 1072 in close proximity to a corresponding bearing surface 1074 on the lower hinge block 1048b. The term “close proximity” can mean the distance between the two structures defines a gap 1076. The size of the gap depends upon the degree to which the actuator 1052 is to be unloaded. A large gap 1076 results in a greater portion of the load being taken up by the actuator 1052 (and holding bolts 1056) before the lower hinge block 1048b deflects enough to close the gap and make contact. A small gap 1076 results in a lesser portion of the load being taken up by the actuator 1052 and holding bolts 1056. Ideally, the gap 1076 should approach zero as the actuator 1052 returns to its original state. In some examples, a gap 1076 in the range of 0.00 to 0.25 cm (0.00 to 0.10 inches) sufficiently unloads the actuator 1052.

The load absorber element 1070 may be formed of any suitable material, such as steel, rubber, silicone, Teflon, copper, etc. In this regard, the material could provide spring-like capabilities, or even comprise a spring. Further, the contact surfaces may include a wear-resistant coating, or a surface treatment such as peening to provide more robust resistance to wear. The contact surfaces could further include a replaceable element fastened to the element 1070.

As can be appreciated with reference to the illustrated embodiment, the first load absorber element 1070a may not unload the actuator 1052 in every situation. For example, if wind pushed the tail vane 1038 in a manner to cause the main body to rotate about the yaw axis in a clockwise direction (as viewed from the top), the lower hinge block 1048b may move away from the first load absorber element 1070a and possibly increase the gap 1076. To counteract this, in some embodiments of the present invention the wind turbine assembly 1010 may include a second load absorber element 1070b in opposing relation to the first load absorber element 1070a. In this manner, a plurality of load absorber elements 1070 could be used to reduce or eliminate the dynamic loads imparted to the actuator, motor, or motor mounts. In one example, the second load absorber element 1070b is positioned with a second bearing surface 1078 in close proximity to a corresponding bearing surface 1080 on the lower cam plate 1060b. In another example, the second bearing surface 1078 can be line-on-line or in contact with the corresponding bearing surface 1080. Various other arrangements are contemplated within the scope of the invention to reduce or eliminate the dynamic loads imparted to the actuator, motor, or motor mounts. Although not illustrated, a bearing (e.g., roller, ball, needle, or the like) may be incorporated as part of the upper and lower cam plates 1060a, 1060b that is adapted to contact the corresponding bearing surface 1080 of the load absorber elements 1070.

In other embodiments, load absorber elements 1070 could be installed in any orientation needed to reduce or eliminate loads on the actuator 1052. For example, and although not illustrated, load absorber elements 1070 could be mounted to the top frame 1014 of the main body and adapted to contact the upper hinge block 1048.

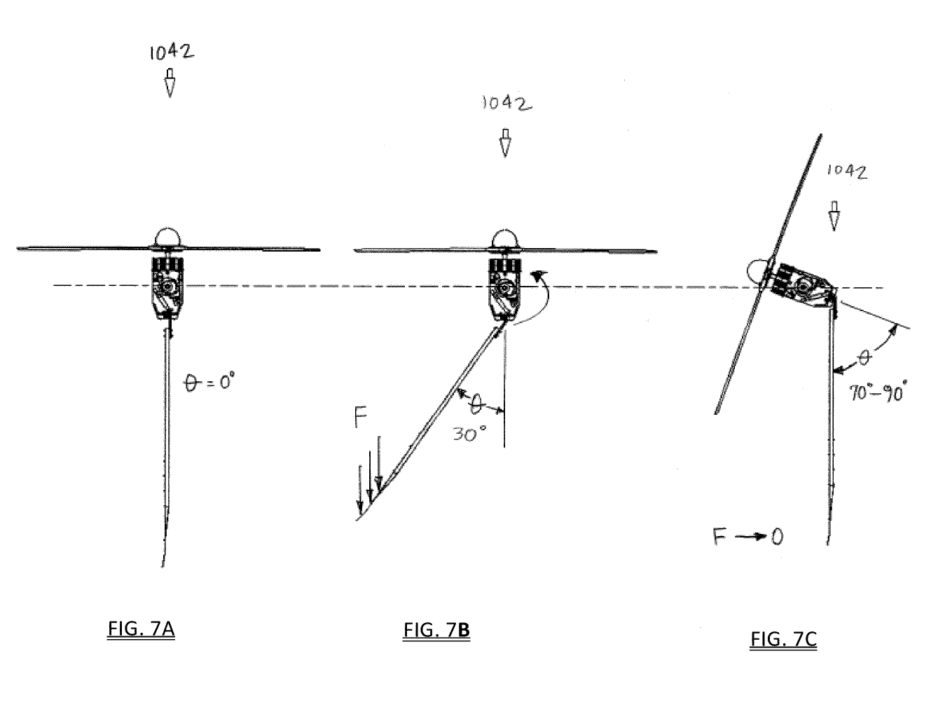

In one embodiment of the invention, one or more load absorber elements 1070c (FIGS. 5 and 6) could be used to lock the tail assembly in the actuated position to further reduce loading on the actuator and motor mounts. The load absorber element 1070c may define a cavity 1071 adapted to capture and lock in place a portion of the actuator or cam assembly, such as the actuator 1052 or at least one of the cam plates 1060a, 1060b. Referring to FIG. 6, in one example when the actuator 1052 extends distance D, the lower cam plate 1060b rotates into place and is captured by the load absorber element 1070c. Bearing surfaces 1080 on the load absorber element 1070c absorb any side loads imparted to the tail boom 1034, thereby reducing the side loads on the actuator 1052. When environmental or operating conditions improve and the actuator 1052 retracts, the cam plates 1060a and 1060b rotate out of the cavity 1071 and resumes normal operation.

In another embodiment of the invention, the load absorber elements 1070 could be arranged such that the tail could be actuated to any intermediate position and be locked into place, removing the stress on the actuator in any position of the tail. In another embodiment, a linear or rotational brake could take the place of the load absorber elements 1070. The brake could effectively lock the tail assembly 1034 in any position whatsoever.

The disclosed system to control the rotation of the tail assembly is exemplary in nature, and is not meant to be limiting. Other suitable arrangements are contemplated within the scope of the invention. For example, other embodiments of the present invention could comprise a motorized tail hinge in which a motor secured to the frame rotates a hinge pin fixed to the tail structure.

Many of the operational parameters of the wind turbine assembly 1010 are monitored and controlled by an on-board computer 1082. In one embodiment, illustrated in FIG. 8, the computer 1082 comprises a programmable logic controller (PLC). PLC 1082 can monitor the state of input devices, make decisions based upon custom program instructions, and control the state of devices connected as outputs.

PLC 1082 includes a PLC controller 1084, terminal blocks 1086 for sensor input lines, and terminal blocks 1088 for output lines. Controller 1084 includes a power supply 1090, a microprocessor 1092, and its associated memory 1094. The memory 1094 of controller 1084 can contain operator or owner preselected, desired values for various operating parameters or limits within the system including, but not limited to, wind speed limits, voltage limits, current limits, alternator temperature limits, and rotor speed limits (which can be converted to tip speed), and any variety or combination of other desired operating parameters or limits. In addition, the desired values or operating parameters may include references to other sensors or values, such that the controller 1084 can determine if any operating parameter is out of range compared to other parameters at any given power level or operating condition. For example, if the rotor speed is X and the alternator current is less than Y, the relationship may indicate a problem exists and the controller 1084 should issue an alert or simply shut down the wind turbine until it can be inspected.

In the disclosed embodiment, controller 1084 includes a microprocessor board that contains microprocessor 1092 and memory 1094, an input/output (I/O) interface 1096, which contains an analog to digital converter which can receive temperature inputs and pressure inputs from various points in the wind turbine or surrounding environment, DC current inputs, and voltage inputs. In addition, I/O interface 1096 may include circuits which receive signals from the controller 1084 and in turn control various external or peripheral devices in the system, such as the actuator 1052, for example. The PLC 1082 may further include one or more communication ports for receiving programming instructions or actuation commands from a remote computer such as a desktop computer, or for monitoring the sensor inputs and other status information available in the PLC memory registers 1094.

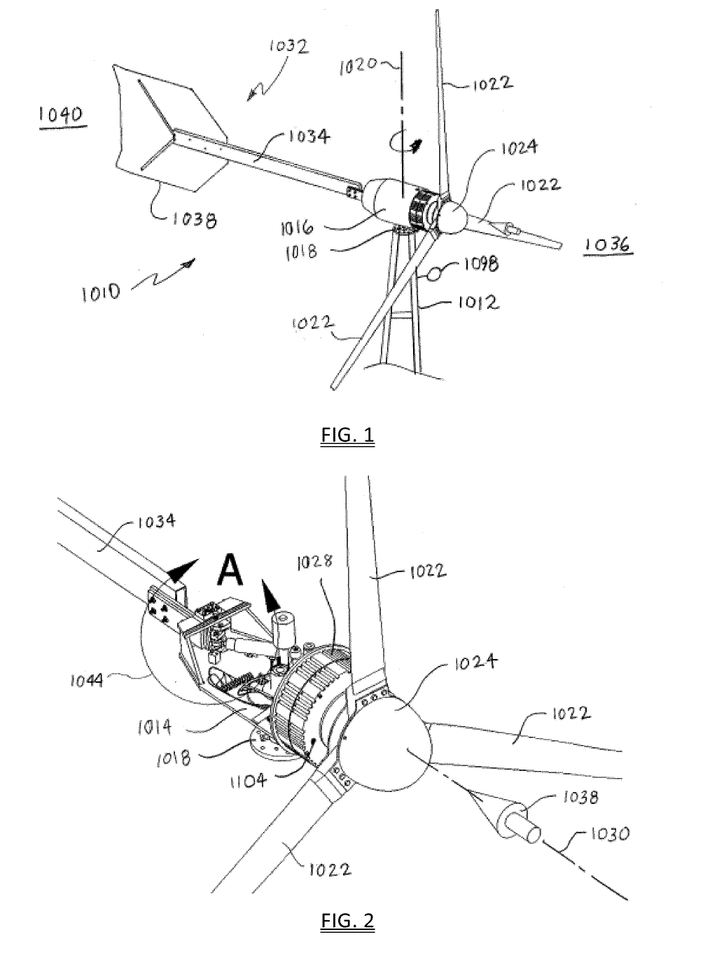

In one embodiment, the primary controlling parameters for the wind turbine assembly are wind speed, alternator voltage, alternator current, and rotational speed of the rotor. Individual sensors monitoring these parameters may input to the PLC a variable current, such as 4-20 milliamps, or a 0-5 volt variable voltage, for example. Among the specific sensors and transducers that may be monitored by PLC 1082 is an anemometer 1098 (FIG. 1), which in one example is a Hall effect sensor counting pulses of voltage and inputting into the microprocessor 1092 voltage pulses at a frequency according to the wind speed. An AC voltage sensor 1100 located in a controller box (not shown) inputs into the microprocessor 1092 a variable voltage value according to the voltage output of the alternator 1028. An AC current sensor 1102 inside the controller box or in the wireway inputs to the microprocessor 1094 a variable voltage or current value corresponding to the current drawn by the system. A temperature sensor 1104 (FIG. 2) inside the alternator inputs into the microprocessor 1094 a variable resistor value according to the alternator temperature. A speed sensor 1106, which may be a Hall effect sensor on the alternator or an AC frequency transducer inside the controller box, inputs into the microprocessor 1092 an inferred RPM value according to the speed of shaft 1026.

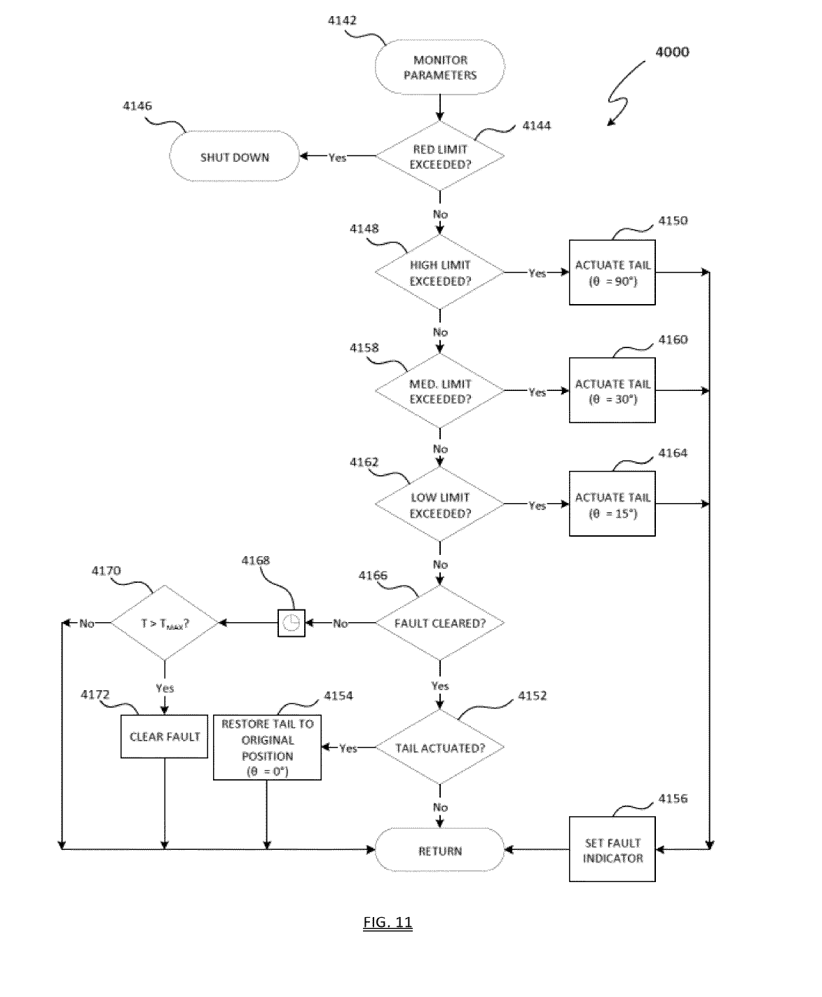

In another embodiment of the invention, illustrated in FIG. 9, wherein like numerals indicate like components from FIG. 8, the computer 2082 is a general purpose computer to provide updates to the PLC code and further provide the user with the ability to monitor, through a user interface, the parameters being measured. The computer 2082 includes a processor 2092 (or CPU) that is coupled to a system bus 2108. Processor 2092 may utilize one or more processors, each of which has one or more processor cores. System bus 2108 is coupled via a bus bridge 2110 to an input/output (I/O) bus 2112. An I/O interface 2096 is coupled to I/O bus 2112. I/O interface 2096 affords communication with various I/O devices, including a keyboard 2114, a mouse 2116, or an external USB port(s) 2118, for example. The format of the ports connected to I/O interface 2096 may be any known to those skilled in the art of computer architecture, such as Ethernet (IEEE 802.3), USB, IEEE 802.11 (WLAN), Bluetooth, CDMA, or any other interface existing or not yet existing, used for the purpose of communicating with the PLC, general purpose computer, and/or any auxiliary devices and/or sensors.

As depicted, computer 2082 is able to communicate with a software deploying server 2120 and central service server 2122 via network 2124 using a network interface 2126. Network 2124 may be an external network such as the Internet, or an internal network such as an Ethernet, or a virtual private network (VPN).

A storage media interface 2128 may also be coupled to system bus 2108. The storage media interface 2128 can interface with a computer readable storage media 2130, such as a hard drive. In a preferred embodiment, storage media 2130 populates a computer readable memory 2094, which is also coupled to system bus 2108. Memory 2094 is defined as a lowest level of volatile memory in computer 2082. This volatile memory includes additional higher levels of volatile memory (not shown), including, but not limited to, cache memory, registers and buffers. Data that populates memory 2094 includes computer 2082's operating system 2132 and application programs 2134.

Operating system 2132 includes a shell 2136, for providing transparent user access to resources such as application programs 2134. Generally, shell 2136 is a program that provides an interpreter and an interface between the user and the operating system. More specifically, shell 2136 executes commands that are entered into a command line user interface or from a file. Thus, shell 2136, also called a command processor, is generally the highest level of the operating system software hierarchy and serves as a command interpreter. The shell 2136 provides a system prompt, interprets commands entered by keyboard, mouse, or other user input media, and sends the interpreted command(s) to the appropriate lower levels of the operating system (e.g., a kernel 2138) for processing. Note that while shell 2136 is a text-based, line-oriented user interface, the present disclosure will equally well support other user interface modes, such as graphical, voice, gestural, etc.

As depicted, operating system 2132 also includes kernel 2138, which includes lower levels of functionality for OS 2132, including providing essential services required by other parts of OS 2132 and application programs 2134, including memory management, process and task management, disk management, and mouse and keyboard management.

Application programs 2134 include a renderer, shown in exemplary manner as a browser 2140. Browser 2140 includes program modules and instructions enabling a world wide web (WWW) client (i.e., computer 2082) to send and receive network messages to the Internet using hypertext transfer protocol (HTTP) messaging or other applicable protocols for communication between computers or between computers and other equipment, thus enabling communication with software deploying server 2120 and other computer systems. For example, browser 2140 can permit communication with a remote client. The ability for a remote client to communicate with the wind turbine's on-board computer 2082 while it is operating atop a tower has many advantages. In one example, program instructions for the PLC 2092 can be revised from a remote location, such as an office, and sent over the Internet to the computer 2082 for execution. In another example, the sensor data from any of the sensor inputs can be monitored from a remote location, and commands can be issued to the PLC 2092 to shut-down or actuate the tail of the wind turbine.

The hardware elements depicted in computer 2082 are not intended to be exhaustive, but rather are representative to highlight components useful by the present disclosure. Variations are intended to be within the spirit and scope of the present disclosure.

FIG. 10 depicts a block diagram of a method 3000 for protecting a horizontal axis wind turbine assembly according to one embodiment of the present invention. The disclosed method can protect the wind turbine from overspeed, electrical grid failures, alternator overheating, inverter fault, overvoltage, overcurrent, or the turbine operating outside of its normal operating power profile. The wind turbine assembly can be manually shut down using a switch on the controller box, for example. It could also shut down if combinations of various parameters don't make sense, such as a high rotor speed and zero current, or vice-versa. The method 3000 includes a monitoring step 3142 in which PLC 1082 receives as input readings from the sensors, such as anemometer 1098, voltage sensor 1100, current sensor 1102, temperature sensor 1104, and speed sensor 1106, for example. At a step 3144, the PLC 1082 compares the sensor readings with “red limit” values stored in memory 1094. Red limit values represent emergency limits which must not to be exceeded for structural or safety reasons. In the event one or more of the red limit values is exceeded, it is not safe to operate the wind turbine either straight or actuated, and the PLC 1082 commands the wind turbine into a hard shutdown at a step 3146. In one example, the red limit value for wind speed is 50 miles per hour. If the anemometer 1098 measured wind speed higher than that value, the wind turbine would undergo a hard shutdown 3146 and come to a full stop.

In one embodiment, the hard shutdown step 3146 comprises actuating the tail assembly 90 degrees to decrease the rotor speed, then throwing a short circuit switch that forces the turbine to stop spinning. The alternator 1028 comprises a 3-phase permanent magnet, so there are three separate circuits generating energy 120 degrees out of phase from each other. Throwing the switch will short the three circuits together, thereby collapsing the magnetic field so the alternator does not spin, or spins very slowly. This hard shutdown step 3146 may also be commanded from a remote computer, which is particularly advantageous during service emergencies. For example, the wind speed may be high enough (e.g., 30⁺ miles per hour) that simply shorting the alternator would result in damage to the internal components due to the high voltage being produced. By first actuating the tail, the rotor speed and concomitant voltage drop off to relatively harmless values.

If the PLC 1082 does not find that any red limit values have been exceeded, it next compares at a step 3148 the sensor readings with one or more threshold values stored in memory 1094. The threshold value represents a limit that should not be exceeded for extended time periods. For example, the threshold value for wind speed may be 35 miles per hour, and the threshold value or limit for rotor speed may be 300 rpm. If the PLC 1082 determines any of the threshold values are above the limit, the PLC 1082 will, at a step 3150, actuate the tail assembly 1032. In one embodiment, the PLC 1082 sends a signal to a relay, which sends power to the motor 1054. The motor 1054 extends the linear actuator 1052 a distance D, which causes the upper and lower cam plates 1060a, 1060b to rotate about the actuator pin 1062. The rotation causes the cam surface 1064 of the cam plates to disengage the contact surface 1050 of the hinge blocks 1048, which then rotates the tail assembly 1032 about the hinge pin 1046. In one embodiment, the PLC 1082 commands the tail to actuate to an angle θ of approximately 90 degrees. The tail assembly remains in the actuated position until the PLC 1082 determines at step 3148 that the threshold value is not exceeded.

When the parameters are below threshold values, such as when the wind speed falls below 30 mph, the PLC 1082 checks, at a step 3152, if the tail is actuated. This can be done by determining the length of travel “D” on the actuator 1052, for example. If the tail is not actuated, the wind turbine is operating within prescribed limits and the method 3000 returns to the monitoring step 3142. If the tail is actuated, and there is no reason for it to be, the PLC 1082 can issue a command to restore the tail assembly to its original position at a step 3154 by removing AC power to the contacts on motor 1054 that are adapted to extend the actuator, and applying AC power to a set of contacts adapted to retract the actuator 1052. The method 3000 then returns to the monitoring step 3142.

In some circumstances, prudence may dictate that the tail assembly remains in the actuated position longer than the time at which the parameter falls below the threshold value. For example, the wind speed threshold value may be 30 miles per hour, and the particular daily weather pattern in which the wind turbine is operating results in continuous wind gusts in a range between 25 miles per hour and 40 miles per hour. If the method of operation includes a step to restore the tail to its original position as soon as the parameter drops below the threshold value, the tail will be constantly cycling between the actuated and unactuated positions as the wind increases above and decreases below 30 miles per hour. In one embodiment of the invention, then, a fault indicator may denote when a threshold value (or “cut-out” value) is exceeded. The normal operation of the wind turbine will cut out and the tail will actuate. The operation will not “cut in” and the tail will not restore to its original position until the fault indicator is cleared, irrespective of the parameter value being below the threshold value.

In one embodiment, the fault indicator is on a timer, and does not clear until the parameter is below the threshold value for a pre-determined amount of time. In the example where the wind speed threshold value is 30 miles per hour, the PLC 1082 can be programmed to clear the fault indicator after the anemometer 1098 indicates the wind speed has been below the threshold limit for a time “T” greater than 30 seconds (e.g., T_{MAX}=30), for example.

In another embodiment, the fault indicator does not clear until a second threshold value is reached. In one example, the wind speed cut-out value is higher than the wind speed cut-in value (e.g., cuts out and actuates at 28 mph, cuts in and restores to its original position at 18 mph). In this manner, the wind speed must decrease well below the threshold value to prevent the wind turbine from constantly cycling between the actuated and unactuated positions.

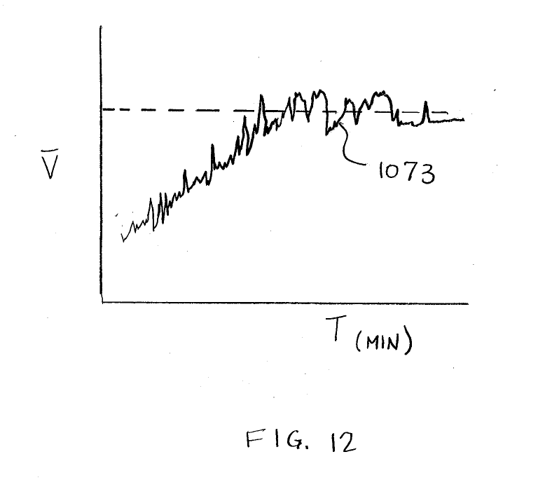

In yet another embodiment of the invention, historical wind data at the wind turbine site can be stored on a computer and called in a logic argument to determine if the tail should be actuated or returned to normal operation at a different time interval. FIG. 12 presents a graph of wind data over a period of time. In one exemplary method of operating the wind turbine, the controller may issue a command to restore the tail to normal operation after the wind velocity is below the threshold limit (shown as dashed line) for two minutes. However, there may be situations where the tail repeatedly actuates in unstable wind conditions. For example, the right-hand side of the graph shows the wind velocity exceeding and dropping below the threshold limit quite often. Were the tail to actuate at every instance, the tail assembly would be subjected to numerous operational cycles, which could lead to premature wear on wind turbine components.

To alleviate this problem, several approaches are contemplated within the scope of the invention. In one example, historical data 1073 could be evaluated to count the number of actuations per hour. Control limits could be established that, upon exceeding a pre-determined frequency, would extend the time required below the threshold wind velocity. The default setting of two minutes could be increased to four minutes, for example. If the number of furls per hour still exceeded a pre-determined limit, the limit could be extended further, for example from four minutes to six minutes.

In another example, the historical data 1073 could be evaluated for trends, and the default operation could be interrupted if trends were spotted. In one implementation, the wind velocity could be time-averaged to determine if the wind is trending upwards, as may be the case with an approaching storm. The data 1073 depicted in FIG. 12 shows a fairly rapid rise in the wind velocity. One could infer from the data that unfavorable conditions were approaching, and the programming logic could be altered to keep the tail actuated for longer time periods to prevent excessive actuations.

In some embodiments of the invention, the tail may be commanded to partially actuate, or actuate to a smaller angle, depending on the severity of the parameter. In this manner, the partially actuated tail will permit the wind turbine to generate more power than in the fully actuated position (e.g., θ=70-90 degrees), thereby increasing its overall efficiency. FIG. 11 depicts a block diagram of a method 4000 for protecting a horizontal axis wind turbine assembly according to such principles. In FIG. 11, like numerals indicate like steps in FIG. 10.

The method 4000 includes a monitor step 4142 in which PLC 1082 receives as input readings from the sensors, such as anemometer 1098, voltage sensor 1100, current sensor 1102, temperature sensor 1104, and speed sensor 1106, for example. At a step 4144, the PLC 1082 compares the sensor readings with “red limit” values stored in memory 1094. In the event one or more of the red limit values is exceeded, the PLC 1082 commands the wind turbine into a hard shutdown at a step 4146.

If the PLC 1082 does not find that any red limit values have been exceeded, it next compares at a step 4148 the sensor readings with a high limit value stored in memory 1094. In this embodiment, the high limit value denotes a limit that should not be exceeded for extended time periods. For example, the high limit value for wind speed may be 35 miles per hour, and the high limit value for rotor speed may be 300 rpm. If the PLC 1082 determines that any of the high limit values are above their respective threshold, the PLC 1082 will, at a step 4150, actuate the tail assembly 1032 to an angle θ equal to approximately 70 to 90 degrees, as shown in FIG. 7C. The method 4000 then proceeds to a step 4156 wherein the fault indicator is set, after which the method returns to the monitoring step 4142.

If the PLC 1082 determines that none of the high limit values have reached their threshold, the method proceeds to a step 4158 to compare the sensor readings with a medium limit value stored in memory 1094. In this embodiment, the medium limit value denotes a limit that, if exceeded, poses moderate risk to the wind turbine. In one example, the medium limit value for wind speed may be in the range of 32-35 miles per hour. If the PLC 1082 determines that any of the medium limit values are above their respective threshold, the PLC 1082 will, at a step 4160, actuate the tail assembly 1032 to a moderate angle θ equal to approximately 30 degrees, as shown in FIG. 7B. The method 4000 then proceeds to a step 4156 wherein the fault indicator is set, after which the method returns to the monitoring step 4142.

If the PLC 1082 determines that none of the medium limit threshold values have been reached, the method proceeds to a step 4162 to compare the sensor readings with a low limit value stored in memory 1094. In this embodiment, the low limit value denotes a limit that, if exceeded, poses low risk to the wind turbine components. In one example, the low limit value for wind speed may be in the range of 28-32 miles per hour. If the PLC 1082 determines that any of the low limit values are above their respective threshold, the PLC 1082 will, at a step 4164, actuate the tail assembly 1032 to a moderate angle θ equal to approximately 15 degrees, for example. The method 4000 then proceeds to a step 4156 wherein the fault indicator is set, after which the method returns to the monitoring step 4142.

If the PLC 1082 determines that none of the red limit, high limit, medium limit, or low limit threshold values have been exceeded, the method 4000 proceeds to a step 4166 to determine if the fault indicator (set in step 4156) has been cleared. As noted above, it may be preferable to delay the step of restoring the tail to its original position even if none of the threshold limits are exceeded. If the fault indicator has not been cleared, the method 4000 proceeds in one embodiment to set a timer 4168. If, as depicted in step 4170, the elapsed time “T” on the timer 4168 (the elapsed time at which all sensor readings have been less than their respective threshold value) is greater than the threshold limit T_{MAX}, the method 4000 proceeds to a step 4172 where the fault indicator is cleared and reset, the method returns to the monitoring step 4142. Otherwise, the delay period has not expired and no action is taken except returning to the monitoring step 4142. As noted above, in other embodiments, steps 4168 and 4170 could comprise a decision as to whether some other delay variable has been met, such as the wind speed cut-in value.

In another embodiment, the limits defined in steps 4148, 4158, and 4162 or the timer 4168 setting may vary depending upon the number of times the limits have been reached within a certain time frame. For example, the first instance a limit (such as low limit 4162) is exceeded, the timer 4168 may be set to 30 seconds. If the limit 4162 is exceeded again, within a certain timeframe for example, the timer 4168 may be set to 60 seconds. If the limit 4162 is exceeded a third time, the timer 4168 may be set to 2 minutes. In this manner, the tail is not actuated any longer than necessary, and the logic accounts for situations in which an occasional gust of wind is not indicative of a consistent weather pattern. Returning to step 4166, if the fault indicator is cleared then there is no reason for the tail to be in the actuated position. At a step 4152, the PLC 1082 checks if the tail is actuated, such as by noting the travel on the actuator 1052, for example, or by checking the status of the contacts. If the tail is not actuated, the wind turbine is operating within prescribed limits and the method 4000 returns to the monitoring step 4142. If the tail is actuated, the PLC 1082 issues a command to restore the tail assembly to its original position at a restore step 4154, illustrated in FIG. 7A, after which the method 4000 returns to the monitoring step 3142.

One advantage of the disclosed wind turbine is that the actuated tail can be used to compensate for the yaw error. As noted, the error may result in a 1%-2% drop in efficiency. Correcting for this error can be difficult because the error is not constant. That is, it varies with wind speed. In one example, then, the position of the tail assembly varies as a function of wind speed to compensate for yaw error.

Another advantage of the disclosed wind turbine is that the actuated tail can compensate or account for multiple configurations of the wind turbine, such as differing blade length configurations. Most prior art wind turbines are protected from overspeed by balancing wind pressure on the blades, offset distances, spring tension, hinges, and gyroscopic forces, and these factors must be kept constant over all the turbines of that size. The balance equation would be completely thrown off if longer blades were put on one of the turbines, for example. All wind turbines have a maximum safe blade tip speed, usually predicated by erosion and vibration concerns (e.g., blade flutter=noise), which is estimated to be 80-100 meters per second for fiberglass blades. This maximum tip speed is driven by tip speed ratio (TSR). For example, a wind turbine having blades designed for a TSR of 1 would have a maximum tip speed of about 80 meters per second. Similarly, blades designed for a TSR of 2 could spin up in 40 meter per second wind speed, and blades designed for a TSR of 4 could spin up in 20 meter per second wind speed.

Many wind turbines are designed for blades with a TSR of about 7 or 8, therefore needing protection in about 11-13 meter per second wind speed (30-35 mph). Thus, the rotor furling mechanism, if present, would operate at 11-13 meter per second wind speed, regardless of the length of blade on the rotor.

In contrast, the inventive wind turbine disclosed herein can be programmed to actuate the tail at any desired condition or wind speed. Therefore, shorter blades could be installed on a wind turbine at a very windy site, or longer blades could be installed on a wind turbine at a relatively calm site. The following examples demonstrate the advantage of this arrangement.

### Example 1

At a typical site, most wind is between 5 and 35 mph, with very little above 35 mph. One exemplary wind turbine according to the present invention (e.g., Configuration A) could include 8 foot blades, and is fully operational between 5-35 mph. Power generation above 35 mph is sacrificed because the tips are moving too fast, but since there is very little wind above 35 mph this is a minor consideration.

### Example 2

At another exemplary site, most wind is between 10 and 45 mph. Left unchanged, the tail of the “Configuration A” wind turbine would actuate at 35 mph, which sacrifices a great deal of capturable wind power. However, the wind turbine according to another embodiment of the present invention (e.g., Configuration B) could include shorter blades, fully operational between 10-45 mph. The tail could be programmed to actuate at 45 mph. The wind turbine does not perform very well below 10 mph because of the short blades, but since there is very little wind below 10 mph this is a minor consideration.

### Example 3

At a third exemplary site, most wind is between 2 and 15 mph. Most prior art wind turbines would not work at this site because they are designed to run optimally in 12-18 mph. Even the “Configuration A” and “Configuration B” wind turbines would perform poorly. Because wind speeds in excess of 30 mph or more are seldom experienced, longer blades can be installed (e.g., 9 feet) and resulting in excellent performance between 4 and 15 mph. Because the blades are longer, the tail needs to actuate at 20 mph, but since there is very little wind above 20 mph this is a minor consideration. A remarkable advantage of the disclosed wind turbine is that it can generate almost as much energy in low-wind sites because of longer blades.

As can be appreciated with reference to the above three Examples, the disclosed wind turbine can operate efficiently in a wide range of wind conditions, with minimal reconfiguration. Whereas prior art passively-controlled wind turbines must precisely balance wind pressure on the blades, offset distances, spring tension, hinges, and gyroscopic forces to optimize operation at a single wind speed, the wind turbine disclosed herein could operate more efficiently with a simple software change, or ideally with a software change accompanying a different length blade set.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. For example, the cam plates may be an optional construction and the system may perform satisfactorily without them. And, although the actuator was described as being retracted when the tail was straight, other configurations are contemplated. For example, the actuator could be extended when tail is straight. Also, while a number of particular embodiments have been described, it will be understood that features and aspects that have been described with reference to each particular embodiment can be used with each remaining particularly described embodiment.

What is claimed is:

1. A horizontal axis wind turbine assembly adapted for use atop a tower, comprising:
a frame;
a yaw shaft assembly coupling the frame to the tower and defining a yaw axis about which the frame rotates;
an alternator secured to the frame;
a shaft coupled to the alternator to produce electrical power, the shaft defining a horizontal axis about which the shaft rotates;
a rotor hub coupled to the shaft;
a plurality of blades secured to the rotor hub;
a tail assembly rotatably coupled about a vertical axis to the frame, the tail assembly operable to move to a first, straight position aligned with the horizontal axis, and a second position rotated an angle θ from the horizontal axis; and
an actuator secured to the frame and adapted to rotate the tail assembly the angle θ from the horizontal axis.

2. The wind turbine assembly according to claim 1, further comprising a load absorber element secured to the frame, the load absorber element coupled with the actuator to reduce dynamic loads from the actuator.

3. The wind turbine assembly according to claim 2, wherein the load absorber element reduces dynamic loads when the tail assembly is in the first, straight position.

4. The wind turbine assembly according to claim 3, wherein the actuator is a linear actuator, and the wind turbine assembly further comprises a cam plate rotatable about the linear actuator to contact the load absorber element.

5. The wind turbine assembly according to claim 2, wherein the load absorber element reduces dynamic loads when the tail assembly is in the second, rotated position.

6. The wind turbine assembly according to claim 1, wherein the second position of the tail assembly compensates for yaw error.

7. The wind turbine assembly according to claim 6, wherein the position of the tail assembly varies as a function of wind speed to compensate for yaw error.

8. The wind turbine assembly according to claim 1, wherein the angle θ is greater than 30 degrees.

9. The wind turbine assembly according to claim 8, wherein the angle θ is greater than 70 degrees.

10. A method of operating a horizontal wind turbine assembly, comprising the steps of:
providing a wind turbine assembly comprising a main body and a tail assembly rotatable about a vertical axis with respect to the main body;
providing an actuator adapted to rotate the tail assembly from a first, straight position to a second position rotated an angle θ from the first position;
determining, by a computer, if a first threshold value of the wind turbine assembly is exceeded;
if the first threshold value of the wind turbine assembly is exceeded, actuating the actuator to rotate the tail assembly through the angle θ,
holding the tail assembly at the angle θ, such that the main body rotates about a yaw axis and the tail assembly realigns with the oncoming wind; and
in response to the first threshold value no longer being exceeded, restoring the tail assembly to the first, straight position.

11. The method according to claim 10, further comprising delaying the step of restoring the tail assembly to the first, straight position until a second threshold value is reached.

12. The method according to claim 11, wherein the second threshold value is a time period.

13. The method according to claim 10, wherein the first threshold value is the yaw error.

14. The method according to claim 10, wherein the first threshold value is wind speed.

15. The method according to claim 10, further comprising the step of reducing dynamic loads on the actuator.

16. The method according to claim 15, further comprising the step of providing a load absorber element to transfer dynamic loads away from the actuator and into the load absorber element.

17. The method according to claim 16, wherein the load absorber element transfers dynamic loads when the tail assembly is in the first, straight position.

18. The method according to claim 16, wherein the load absorber element transfers dynamic loads when the tail assembly is in the second, rotated position.

19. The method according to claim 10, wherein the step of determining if a first threshold value is exceeded comprises receiving actuation commands from a remote computer in communication with the wind turbine assembly computer.

20. The method according to claim 10, wherein the step of determining if the threshold value is exceeded comprises using historical wind data to determine if the tail should be actuated for longer periods of time.

21. The method according to claim 20, wherein the historical data is evaluated by the computer to spot trends.
